(19) United States
(12) Patent Application Publication
(10) Pub. No.: US 2018/0089746 A1
(43) Pub. Date: Mar. 29, 2018

(54) FACILITATING TRANSFER, ORGANIZATION, DISTRIBUTION OF PHOTOGRAPHIC IMAGES

(71) Applicants: Tatiana B. Cooke, Dallas, TX (US); Veton Hajdari, Keller, TX (US)

(72) Inventors: Tatiana B. Cooke, Dallas, TX (US); Veton Hajdari, Keller, TX (US)

(21) Appl. No.: 15/718,819

(22) Filed: Sep. 28, 2017

Related U.S. Application Data
(60) Provisional application No. 62/401,146, filed on Sep. 28, 2016.

(51) Int. Cl. G06Q 30/06; G06Q 20/12

(52) U.S. Cl. CPC G06Q 30/0635; H04W 4/12; G06Q 20/12

(57) ABSTRACT

To facilitate on-demand professional photography services at a location of a customer's choice, an app within the customer's mobile device communicates a request with location information to a server. Location information derived by the server from apps executing within the mobile devices of photographers available to provide on-demand professional photography services allow location matching, to provide the customer with one or more choices. Upon selection of a photographer by the customer, the images captured by the photographer are stored in a database based on a customer identifier for the customer, a photographer identifier for the photographer, and a transaction identifier for the request. The storage configuration facilitates retrieval of captured images from photographers, provision of access to preview or full resolution images to customers, and transaction processing for purchase of the service and/or images.

### PRIORITY CLAIM AND CROSS-REFERENCE TO RELATED APPLICATIONS

This application claims priority to U.S. Provisional Application No. 62/401,146 filed Sep. 28, 2016 and titled “FACILITATING TRANSFER, ORGANIZATION, DISTRIBUTION OF PHOTOGRAPHIC IMAGES.” The content of the above-identified patent document is hereby incorporated by reference.

### TECHNICAL FIELD

The present application relates generally to providing on-demand professional photography services at a customer-designated location, a service not previously contemplated in the art, and, more specifically, to facilitating the matching of customers and contract, freelance photographers as well as facilitating transfer, organization, distribution for preview or sale, and payment for photographic images in connection with such novel provision of on-demand professional photography services at a customer-designated location.

### BACKGROUND

The “selfie” or self-taken picture of one's self has become a ubiquitous feature of contemporary society. Selfies abound on social media sites, used to document attendance at events or visits to famous attractions. The taking of selfies with celebrities, world leaders, or other important or famous people has become the modern equivalent of asking for an autograph. Smart phones with forward facing cameras as well as rear facing cameras are now common, and other accessories such as the “selfie stick” are widely marketed.

Despite their popularity, selfies are limited in several respects. Camera features such as focal length or wide angle optical lens, optical zoom, auto exposure, autofocus, and face or object recognition for focal point selection are not uniformly available in all smart phones. Alternatives such as manual focus or exposure settings may be complicated to use even when available. Even with a selfie stick, which allows selfies to be taken from a broader viewpoint, the range of possible perspectives is limited for an actual selfie. Asking another person to take the picture using one's smart phone may risk theft of that phone. Factors such as composition and framing typically considered by trained or professional photographers are not generally also considered by amateur photographers taking selfies. Group “selfies” can be particularly challenging.

There is, therefore, a need in the art for alternatives to the selfie.

### SUMMARY

A server comprises: a memory configured to store images organized by each of a customer identifier for a customer among a plurality of customers, a photographer identifier for a photographer among a plurality of photographers, and a transaction identifier, each of the plurality of customers having a unique customer identifier and each of the plurality of photographers having a unique photographer identifier; a transceiver configured to communicate over a network with a first app executing on a first mobile device associated with the customer and having a first customer identifier for the customer, to communicate with a second app executing on a second mobile device associated with the photographer and having a first photographer identifier associated with the photographer, to send messages to and receive messages from the first app via the network, to send images to the first app via the network, to send messages to and receive messages from the second app via the network, and to receive images from the second app via the network; and a processor configured to generate messages to be sent using the transceiver and to process messages received by the transceiver. The processor is further configured to: receive, from the first app, a first message requesting on-demand professional photography services; in response to receiving the first message, assign a unique transaction identifier to the request for on-demand professional photography services from the first app and determine a location of the first mobile device; based on the determined location of the first mobile device, identify a location of the second mobile device as matching a geographic area defined to encompass the location of the first mobile device; in response to identifying the location of the second mobile device as matching the geographic area defined to encompass the location of the first mobile device, initiate transmission of a notification message to the second app of the request for on-demand professional photography services at the location of the first mobile device; subsequent to initiating transmission of the notification message, receive, from the second app, a confirmation message for acceptance of the request for on-demand professional photography services at the location of the first mobile device; subsequent to receipt of the confirmation message, receive a message from the second app associated with one or more images available for retrieval from a remote storage device; and cause the one or more images to be stored in the memory for access by the first customer identifier, the first photographer identifier, and the transaction identifier for the request for on-demand professional photography services from the first app.

The processor is optionally further configured to, subsequent to causing the one or more images to be stored in the memory, initiate a first payment transaction with the first app for purchase of one or both of: the requested on-demand professional photography services; or at least one of the one or more images resulting from the requested on-demand professional photography services.

The processor is optionally further configured to, prior to initiating the first payment transaction with the first app, provide a link to the first app for preview of the one or more images and receive an identification from the first app of each of the one or more images to be purchased via the payment transaction.

The link is optionally configured to permit limit-duration access to preview images on a website.

The processor is optionally further configured to, subsequent to completing the first payment transaction with the first app, initiate a second payment transaction with the second app for payment for the on-demand professional photography services resulting in the one or more images.

The second app is optionally configured to wirelessly receive images from a camera employed by the photographer.

The first app and the second app are optionally a single app operating in a customer mode to form the first app and in a photographer mode to form the second app.

A first app configured to execute on a mobile device having a memory, a processor, and a transceiver includes machine executable instructions that, when executed, cause the processor to: transmit, to a server, a first message for a request for on-demand professional photography services and including information enabling determination of a location of the mobile device, wherein a unique transaction identifier is assigned to the request for on-demand professional photography services; process a received indication of at least one photographer for providing the requested on-demand professional photography services that has been identified as having a location matching a geographic area defined to encompass the location of the mobile device; transmit, to the server in response to the received indication, an acceptance of a photographer among the at least one photographer for the requested on-demand professional photography services; and subsequent to occurrence of the requested on-demand professional photography services by the accepted photographer, process a message associated with a customer identifier for a customer using the mobile device, a photographer identifier associated with the accepted photographer, and the transaction identifier making one or more images stored remotely available for preview access by the customer identifier, the photographer identifier, and the transaction identifier.

The first app is optionally configured to cause the processor to, in conjunction with processing the message, process a payment transaction for purchase of one or both of: the requested on-demand professional photography services; or at least one of the one or more images resulting from the requested on-demand professional photography services.

The message optionally contains a link for preview of the one or more images and wherein the machine executable instructions are configured to cause the processor to, during processing of the payment transaction, initiate transmission of an identification of each of the one or more images to be purchased via the payment transaction.

The message optionally includes a link configured to permit limited-duration access to preview images on a website.

The first app is optionally configured to cause the processor to, subsequent to completing the payment transaction, receive a link for access to full resolution versions of the one or more images purchased via the payment transaction.

The first app is optionally configured to cause the processor to, subsequent to completing the payment transaction, receive a receipt for payment for at least the on-demand professional photography services resulting in the one or more images.

A second app configured to execute on a mobile device having a memory, a processor, and a transceiver includes machine executable instructions that, when executed, causes the processor to: transmit, to a server, a first message indicating availability to provide on-demand professional photography services and including information enabling determination of a location of the mobile device; process a received indication of a request for on-demand professional photography services by a customer identified as having a location matching a geographic area defined to encompass the location of the mobile device, wherein a unique transaction identifier is assigned to the request for on-demand professional photography services; transmit, to the server in response to the received indication, an acceptance of the request for on-demand professional photography services and, subsequent to occurrence of the requested on-demand professional photography services, one or more images captured during the occurrence of the requested on-demand professional photography services, wherein each of the one or more transmitted images has associated therewith a customer identifier for a customer that requested the on-demand professional photography services, a photographer identifier associated with the photographer, and the transaction identifier.

The second app is optionally configured to cause the processor to, subsequent to transmission of the one or more images, process a payment transaction for payment to the photographer for one or both of: the requested on-demand professional photography services; or at least one of the one or more images resulting from the requested on-demand professional photography services.

The second app is optionally configured to cause the processor to wirelessly receive images from a camera employed by the photographer.

The second app is optionally configured to cause the processor to transmit an indication of availability of the photographer to provide on-demand professional photography services.

The second app is optionally configured to cause the processor to periodically transmit an updated indication of a location of the mobile device.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any hardware device that controls at least one operation, whether based upon firmware or user-supplied software executing within the controller. It should be noted that the functionality associated with any particular controller might be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like reference numerals represent like parts, and in which:

FIG. 1 is a diagram of a system within which an app and app server are implemented for facilitating transfer, organization, and distribution of photographic images in connection with providing on-demand professional photography services at a customer-designated location in accordance with various embodiments of the present disclosure;

FIG. 2 is an annotated diagram for a process of providing on-demand professional photography services at a customer-designated location in accordance with one embodiment of the present disclosure;

FIGS. 3A through 3K depict representative user interfaces for the app on the customer's smart phone employed to provide on-demand professional photography services at a customer-designated location in accordance with one embodiment of the present disclosure; and

FIGS. 4A through 4E depict representative user interfaces for the app on the photographer's smart phone employed to provide on-demand professional photography services at a customer-designated location in accordance with one embodiment of the present disclosure.

### DETAILED DESCRIPTION

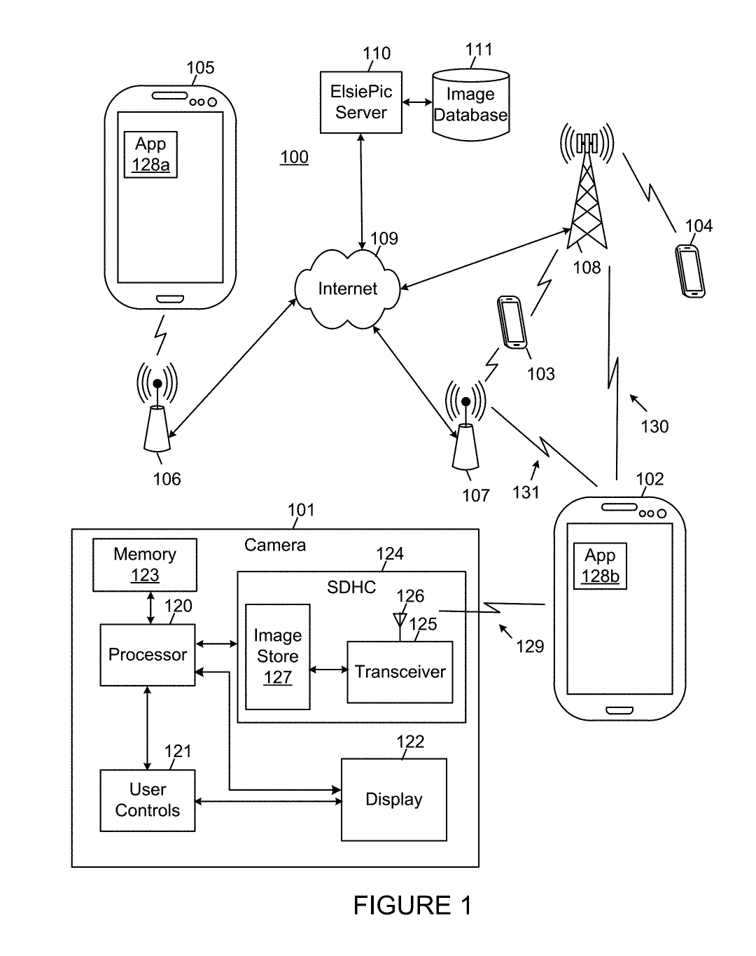

FIGS. 1 through 4E, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

Individuals vacationing at popular locations will generally want pictures of themselves in front of recognizable attractions. For some attractions, geographic or physical constraints may facilitate the provision of professional photographic services as an alternative to the selfie at some attractions. Other locations, however, are either not amenable to limiting competition by professional photographers due to the size of the attraction or do not economically warrant full-time staffing of professional photographic services. For example, the Eiffel Tower in Paris is located at one end of the Champ de Mars, a large public greenspace within which the Eiffel Tower may form a suitable backdrop for pictures of individuals taken anywhere within several acres. Times Square in New York City and the Las Vegas strip include numerous different attractions across a large area. In addition, some people may want different or unique pictures distinct from a “standardized” backdrop, such as from a different perspective around the attraction (e.g., with the Eiffel Tower in the background from a hotel room balcony).

There is, therefore, a need for on-demand, freelance professional photography services akin to other types of on-demand services, such as transportation (Uber or Lyft), temporary lodging, storage, or office space (Airbnb, Roost or LiquidSpace), parking (Spot or ParkingPanda), or delivery (Postmates or DoorDash). An on-demand, freelance professional photography service would allow customers to request a photographer available within their geographic area and already prepared to take pictures upon their arrival at the customer location.

Several problems distinguish on-demand, freelance professional photography from the other types of on-demand services mentioned above. For example, in contrast to on-demand transportation, transportation is actually an obstacle to the delivery of on-demand, freelance professional photography in many situations. A much more limited geographic range is available for “matching” a customer and available photographer when the photographer is limited to walking or using a bicycle. Even with an automobile, the availability of parking at the customer's chosen locale complicates the selection of geographic range. More significantly, product preview is impossible until after the on-demand service has been performed, and transfer or distribution of only the customer-selected images (from among the previewed images) must be coordinated with payment to ensure that both the customer and the photographer honor the agreement. The present disclosure addresses such issues of geographic coordination, product preview, and selected product (image) delivery upon payment. It should be noted that the term “image,” as used herein, includes video images with associated audio as well as still images.

FIG. 1 is a diagram of a system within which an app and app server are implemented for facilitating transfer, organization, and distribution of photographic images in connection with providing on-demand professional photography services at a customer-designated location in accordance with embodiments of the present disclosure. The system 100 includes a camera 101 and one or both of a smart phone 102 and/or a tablet 103 in the possession of a freelance, on-demand photographer, together with smart phones 104, 105 or the like in the possession of customers. Each of the smart phones 102, 104, and 105 and the tablet 103 includes a wireless transceiver (not shown) for wireless voice or data communications with other devices via one or more of a wireless fidelity (WiFi) network or other wireless local area network (LAN) via access points 106 and 107, a wireless wide area network (e.g., WiMAX), or a broadband wireless voice and data communications network (e.g., 4^{th} Generation Long Term Evolution or “4G LTE”) via base station 108. The mechanism by which certain wireless communications used during provision of on-demand professional photography services at a customer-designated location in accordance with the present disclosure is not critical, although specific communications for which the mechanism is important will be described below. Each of the smart phones 102, 104, and 105 and the tablet 103 also includes one or more processors or controllers (not shown) configured to control transmission and reception of wireless communications, as part of processes described below in connection with the process flow diagrams.

Each of the smart phones 102, 104, and 105 and the tablet 103 further includes at least one software program (or “application” or “app,” not shown) stored in a memory or memories (not shown) within the respective device. The memory or memories are communicably coupled to the processor(s)/controller(s). Selective execution under control by a user of the app on the processor(s)/controller(s) of the respective device facilitates transfer, organization, and distribution of photographic images in connection with providing on-demand professional photography services at a customer-designated location in accordance with embodiments of the present disclosure. The memory or memories in the smart phones 102, 104, and 105 and the tablet 103 also stores images that are the object of the on-demand professional photography services in accordance with the present disclosure. Each of the smart phones 102, 104, and 105 and the tablet 103 communicates via the wireless communications to the internet 109, to which is connected a server 110 that selectively accesses an image database 111, to copy or transfer the images that are the object of the on-demand professional photography services. Each of the smart phones 102, 104, and 105, and preferably also the tablet 103, includes location determination capabilities coupled to the processor within the respective device. For example, a global positioning system (GPS) receiver or WiFi-based location system provides location information for the respective device to the processor in that device under control of that processor.

The camera 101 in the exemplary embodiment includes a processor 120 receiving input from and operating in response to user controls 121. The optics subsystem (not shown) within the camera 101 enables the taking of high quality, and preferably high resolution, images. A display 122 on camera 101 is coupled to processor 120 and user controls 121, to display the field of view of the optics subsystem and/or captured images. Camera 101 is preferably a digital single-lens reflex (DSLR) camera. Camera 101 may employ up to or exceeding 20.8 mega-pixel (MP) still image resolution and comparable video resolution such as 4,000 pixel (4K) resolution. Camera 101 includes an integral memory 123 for storing captured images, as well as a cable connection (universal serial bus or “USB”) and/or integral WiFi communications capabilities to copy or transfer images from the integral memory to an external device.

In a preferred embodiment, independent of the existence of integral memory and communications capabilities in camera 101, camera 101 includes a receptacle for a removable memory card 124, such as a secure digital high capacity (SDHC) memory card. Camera 101 is configured to selectively store captured images to the memory card 124. In a preferred embodiment, the memory card 124 has built-in WiFi capabilities in the form of an integrated transceiver 125 and antenna 126, together with associated programmable control circuitry (not shown), coupled to an image store 127 within the memory card 124. Accordingly, for example, memory card 124 may be one of various models of wireless SDHC memory cards available from Eye-Fi, Inc., which provide for secure transfer of images from the respective memory card 124 directly to a separate device such as a phone, laptop, or tablet via a direct WiFi connection.

In operation, the system 100 facilitates transfer, organization, and distribution of photographic images in connection with providing on-demand professional photography services at a customer-designated location. The app 128a executing in customer mode on customer smart phone 105 enables the user to request on-demand professional photography services at the customer's current location, which request is assigned a unique transaction identifier. The location is of the customer's choosing, and may be a popular attraction or a locale reasonably proximate to highly-traveled areas, such as a restaurant. The customer uses the app 128a with a unique customer identifier on smart phone 105 to transmit a request for professional photography services to the server 110. The app 128a automatically captures location information for the customer's smart phone 105 and provides that location information as part of the request.

Available freelance photographers use the app 128b with a unique photographer identifier executing in photographer mode on smart phones and/or tablets 102, 103 to communicate availability to provide on-demand photography services. At the start of their availability, when the freelance photographer initiates indication of availability for either a defined or preset period (e.g., two hours) or indefinitely until an indication of non-availability, the app 128b on the smart phone 102 or tablet 103 for the freelance photographer automatically captures location information for the respective smart phone 102 or tablet 103 and provides that location information to the server 110 as part of the indication of availability. Periodic updates of the location information for the freelance photographer are sent by the smart phone 102 or tablet 103 to the server 110 during the entire period of indicated availability (e.g., until the freelance photographer indicates that they are no longer available for that day to provide photography services).

Of course, the indication by a freelance photographer of general availability to provide photography services within a geographic region is considered subject to other factors when matching a photographer to a customer request. For example, when a freelance photographer uses the app 128b to accept an engagement to provide services to a customer, that photographer is considered unavailable until the services are determined to be complete, either implicitly through submission of payment requests or explicitly by an indication provided by the photographer through the app. Similarly, hours of operation for a particular attraction or venue may also be considered, as well as emergency closure of the attraction or venue, the hours of operation for any necessary transportation services (such as a bus, shuttle or light rail system), the battery power remaining for the photographer's camera, and/or similar factors that might preclude the photographer from traveling to the customer location and providing services in a timely manner.

The self-reported (and/or independently verified) availability of equipment for use by a particular freelance photographer may also be tracked by the server 110 as part of prospectively matching freelance photographers to a customer request. For instance, the resolution of the photographer's digital camera may be a consideration. Likewise, availability of flash or other auxiliary lighting (or low-light capable photographic equipment) or of light reflectors, wide angle or telescopic lenses, filters, tripod or monopod stabilizing supports, video (and associated audio) capabilities including microphones, an assistant (e.g., to hold a light reflector in position), and the like may all be taken into account during matching of a customer request to each available freelance photographer.

The server 110 tracks the availability and corresponding location information for all freelance photographers using the app 128b to participate in on-demand professional photography services, with the other considerations discussed above likewise stored in association with each prospectively matching freelance photographer. When the request for such professional photography services is received from the app 128a on the customer's smart phone 105 by the server 110, the server undertakes to match the request (using at least the location information within the request) with one of the available freelance photographers that has indicated current availability from a location proximate to the customer's smart phone 105. The matching process preferably takes into account an array of factors: geographic distance between the customer's smart phone 105 and the most recently reported location of each freelance photographer; self-reported availability of automotive transportation (if necessary) for the freelance photographer to travel to the location of the customer's smart phone 105, and the availability of parking in the region of the customer's smart phone 105; whether the customer's smart phone 105 is located in a restricted venue, such as at a concert venue or in a theme park, and if so whether each freelance photographer is reported to be present within that venue; past reliability of each freelance photographer, based for example of prior reports of “no shows” by previous customers; and such other factors as are considered relevant.

Upon completing the initial portion of the process for matching a customer requests with one or more available freelance photographers, the server 110 proceeds to coordinate the provision of on-demand professional photography services in one of several ways. If the customer request indicated a desire to obtain the fastest-available service, the server 110 may independently determine which of the potentially-matching freelance photographers is positioned to reach the customer location the fastest. The app 128b in the smart phone 102 or tablet 103 for that specific photographer may then be sent, by the server 110 without further approval or input by the customer, an engagement to provide photographic services at the customer's location, with information for identifying the customer and for use by the photographer in authenticating themselves to the customer. The photographer may accept or decline the engagement sent by the server 110 using the app. If the first-selected photographer declines the engagement, the server 110 may then send the engagement to an available freelance photographer deemed next most likely to reach the customer's location the fastest. Once an acceptance of the engagement from freelance photographer's smart phone 102 or tablet 103 is received by the server 110, the server 110 may then send information regarding the photographer to the app on the customer's smart phone 105. The information regarding the photographer should include the photographers name and a head shot, an authentication indicia (e.g., a “badge” number or authentication codeword), and preferably also an estimated time of arrival at the customer's location. In some embodiments, information for displaying a map illustrating the photographer's current location relative to the customer's location (and updated with the photographer's travel progress toward the customer's location) may be provided by the server 110 to the app executing on the customer's smart phone 105.

Alternatively, the customer making the request for on-demand professional photography services may elect to choose from available photographers within the geographic area of the customer's location. In such cases, the server 110 may use the results of the initial matching process to communicate (before sending an engagement notification to any photographer) a list to the customer's smart phone 105 of prospective photographers to fulfill the customer's request, for display by the app on the customer's smart phone 105. Ancillary information regarding each photographer may also be provided for selective access within the app on the customer's smart phone 105. For example, distance and/or estimated travel time for each photographer may be provided (either in text form or illustrated by a map). Ratings for each photographer by prior customers who have used that photographer may also be provided. Links to examples of each photographer's past work may be provided, for access by the customer using the app in the smart phone 105.

In the alternative selection process, the customer employs a user control in the app on the smart phone 105 to indicate to the server 110 which photographer the customer would prefer to receive the engagement for providing on-demand professional photography services. The server 110 then sends an engagement notification to the smart phone 102 or tablet 103 for the customer-selected photographer, and the photographer may indicate to the server 110 whether they accept or decline the engagement using the app on the smart phone 102 or tablet 103. If the photographer declines the engagement, the server 110 may transmit to the app on the customer's smart phone 105 an indication that the photographer has become otherwise engaged, and display an updated list of prospective photographers to the customer in the app for selection of a second or alternate choice. Once an engagement to the customer's choice of photographer has been accepted, the information regarding the photographer that was described above is sent to the app in the customer's smart phone 105.

Based on an accepted engagement for providing on-demand professional photography services, a photographer captures images as desired by the customer using camera 101. In a preferred embodiment, the captured images are stored in memory card 124. The app 128a disables cellular communication in phone 102 (or tablet 103) leaving WiFi transceiver in phone 102 enabled to connect to memory card 124 using the WiFi capabilities of the memory card 124. The captured images are transferred via WiFi connection 129 from memory card 124 to phone 102. Preview versions of the captured images may be extracted from the captured images and stored in phone 102 and/or possibly transmitted to server 110 as described below. The captured images are stored in secure, private memory within the phone 102 accessible only to the app 128a, preferably with encryption frustrating attempts to circumvent control by the app 128a over the captured images.

Once the captured images are transferred from memory card 124 to phone 102, the app 128a restores cellular communications 130 from the phone 102 to server 110 for secure transfer by the app 128a via cellular data to the server 110, where the captured images are stored in association with the customer identifier for the customer that initiated the request, the photographer identifier for the photographer that provided the services, and the transaction identifier for the request. Each captured image may have a unique image identifier. In alternative embodiments, connection 131 to a local WiFi access point 107 accessible to phone 102 may be employed for communication via internet 109 to the server 110, to transfer the captured images to server 100 in lieu of using cellular data connection 130. Sufficient bandwidth communication resources must be available (either via WiFi or cellular data) for transfer of at least the full resolution images (rather than just reduced-resolution preview images) to the server 110. Preview resolution versions may also be transferred, or alternatively the server 110 may regenerate preview resolution versions of the captured image from the full resolution images received. The full resolution (and optionally preview resolution) images received by server 110 from the memory card 124 may be stored by within image database 111, marked for relation to the customer request and the engaged photographer. The storage arrangement of captured images in the manner described facilitates operation of the server 110 in storing captured images received from the photographer, providing previews or final images to the customer either directly or via a website, and completing transactions for payment by the customer and to the photographer.

As noted, the full resolution images on the memory card 124 are preferably encrypted prior to transfer to prevent the image data from being copied or distributed by the photographer without using the server 110 (and the service contemplated herein). In that regard, the use of Eye-Fi memory card products is preferred, to provide secure and controlled transfer of the preview and full resolution captured images from the memory card 124 to the server 110. That is, the memory card 124 may be programmed to restrict copying or transfer of the images (either or both of preview and full resolution) from the memory card to only designated Eye-Fi cloud storage, from which only the server 110 can retrieve those images.

To better facilitate customer selection from among more than one captured image, preview images may be generated on phone 102 (or tablet 103) or sent from the server 110 to the app executing on the photographer's tablet 103 (or, if the photographer's smart phone 102 has a sufficiently large display, to the app 128a executing on the photographer's smart phone 102). The preview images are preferably lower resolution and marked with an overlay to discourage screen capture. The app allows the customer to browse the images available for selection, choose one or more images, and indicate the selection(s) to the server 110 using the app on the photographer's tablet 103 or smart phone 102.

Upon selection of images, payment for the on-demand professional photography services may be processed, using payment arrangements previously established by the customer. The payment includes a fee for the photographer, and may include charges for each image selected above a predetermined number. Upon successful processing of payment by the server 110, a limited-duration (that is, active and usable only for a limited time) link and instructions for downloading full resolution images is provided to the smart phone 105, or to an e-mail for the customer. To the extent that full resolution images were not loaded to the image database 111 immediately following the photography services, the photographer is required to load the images within a predefined time of the photography session and the link for downloading is sent when the full resolution images become available.

Process for Photographer and Customer Sync.

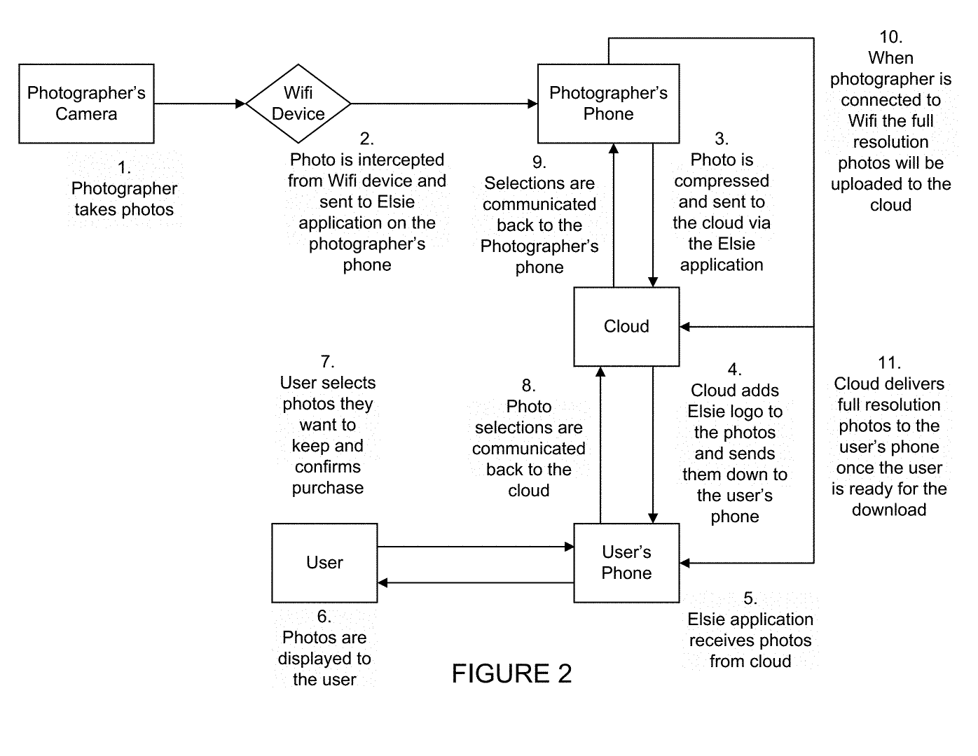

FIG. 2 is annotated diagram for a process of providing on-demand professional photography services at a customer-designated location in accordance with one embodiment of the present disclosure. Within the process depicted:

1. Photographer and customer meet.

2. If customer still decides to cancel at this point there will be a $3 cancellation fee

3. Photographer clicks on start photo shoot.

4. Photoshoot begins.
a. Photographer can only take x number of photos per session.
   i. Cost $5+2.99 a photo.
   ii. $5 fee includes 1 free picture
   iii. Launch Eye-Fi app
   iv. Shoot photos (at his discretion)
   v. Check Eye-Fi (or ElsiePic?) app to ensure the photos were transferred to phone

5. Photographer clicks “End Photoshoot” when the shoot has ended.
a. Photographer is credited $5 for the photo shoot
b. Customer has a choice of NOT selecting any photos

6. LTE will now activate on the phone

7. Photos stream from photographers phone to customers phone.

8. Customer can preview all photos.

9. Customer is prevented from taking a screenshot of the photos.

10. Customer can purchase any photos that are selected.

11. All photos are kept and can be purchased at any time.

12. Photos will be archived for 30 days, and delete them if they have not been purchased.

User Interfaces for Photographer and Customer.

Those skilled in the art understand that app 128a on the customer's smart phone 105 and app 128b on the photographer's smart phone 102 (or tablet 103) may be the same app operating in different modes (e.g., “customer mode” and “photographer mode,” respectively), or may be counterpart apps that interoperate and are each downloaded by a user depending on whether participation in the service as a customer or a photographer is desired.

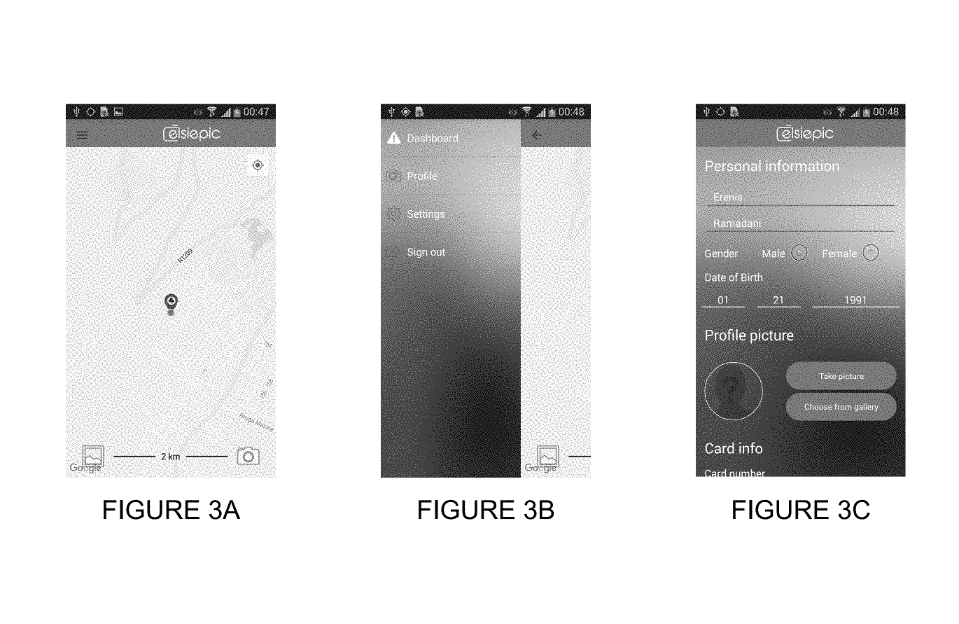

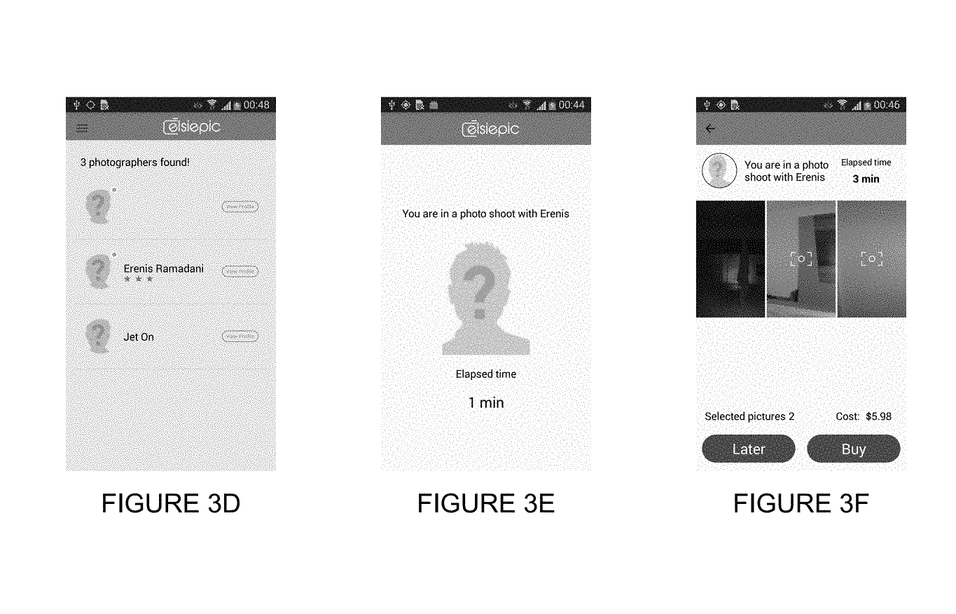

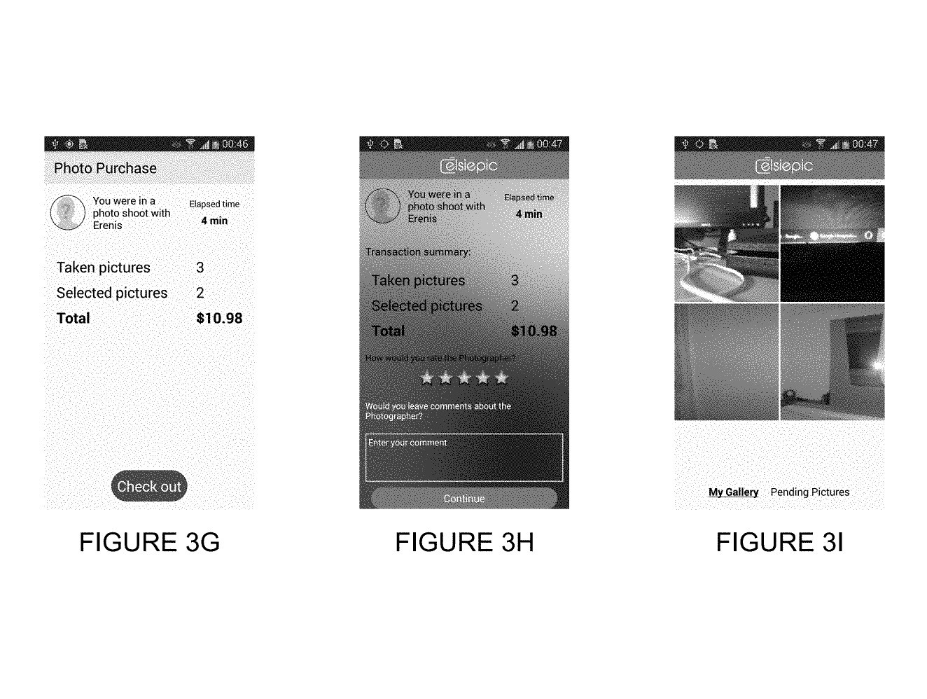

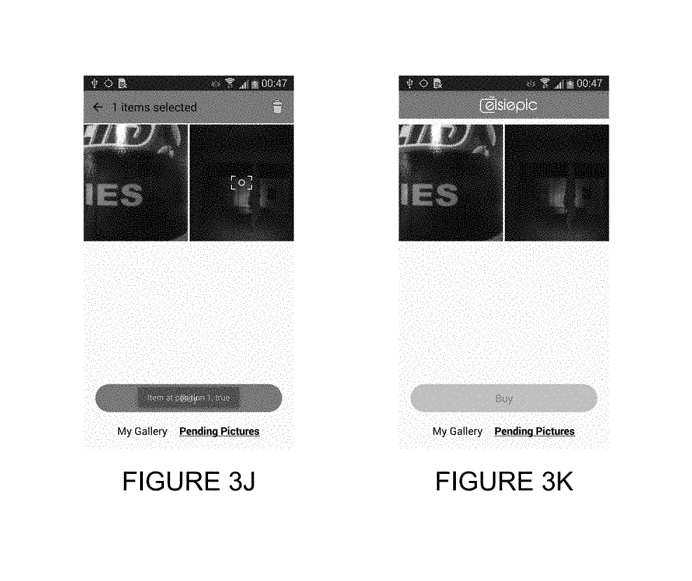

FIGS. 3A through 3K depict representative user interfaces for the app 128a on the customer's smart phone 105. Those skilled in the art will recognize that all user interfaces are not depicted. Instead, for simplicity and clarity, only selected user interfaces significant to the ordered sequence of steps for the process described are shown. In FIG. 3A, the app 128a displays a customer's current geographic location, represented by the blue dot. FIG. 3B illustrates the customer's dashboard by which the customer may control various aspects of the app. In FIG. 3C, for example, the customer is adding or updating identifying information (in “Profile”) by which a photographer can recognize the customer. The “Settings” menu in FIG. 3B allows the customer to specify various photographer criteria for matching discussed above, such as equipment or rating by other customers.

Referring back to FIG. 3A, the location of available photographers is also shown (by the red marker) relative to the customer. In the example depicted, all photographers are co-located with the customer, although the photographers will generally be dispersed and such dispersion will be apparent in geographic views with higher resolution than that depicted. The customer may actuate a red marker to learn more about the respective photographer.

When the customer requests services, a list of potentially matching photographers is displayed, such as shown in FIG. 3D. In the example of FIG. 3D, three potential matches are displayed, and the customer may view additional information about each (such as equipment or rating) by selecting one of those listed. The customer may select one of the available photographers and, when the photographer arrives and begins the photoshoot, will receive a status update such as shown in FIG. 3E. Once images have been captured and preview resolution versions generated, the preview resolution images will be displayed to the customer for selection as shown in FIG. 3F. The customer may complete a purchase of images as shown in FIG. 3G, and will receive confirmation of the purchase as shown in FIG. 3H. The full resolution images purchased will then be available for download (shown by actuating the “My Gallery” link) by the customer by selection of each image as shown in FIG. 3I. Selection of an image (shown by the focus reticle on the right image, after actuating the “Pending Pictures”) will initiate download to the customer's smart phone as shown in FIG. 3J. The customer is also provided with an option to purchase images previously not purchased from the photoshoot, using the “Buy” control shown in FIG. 3K.

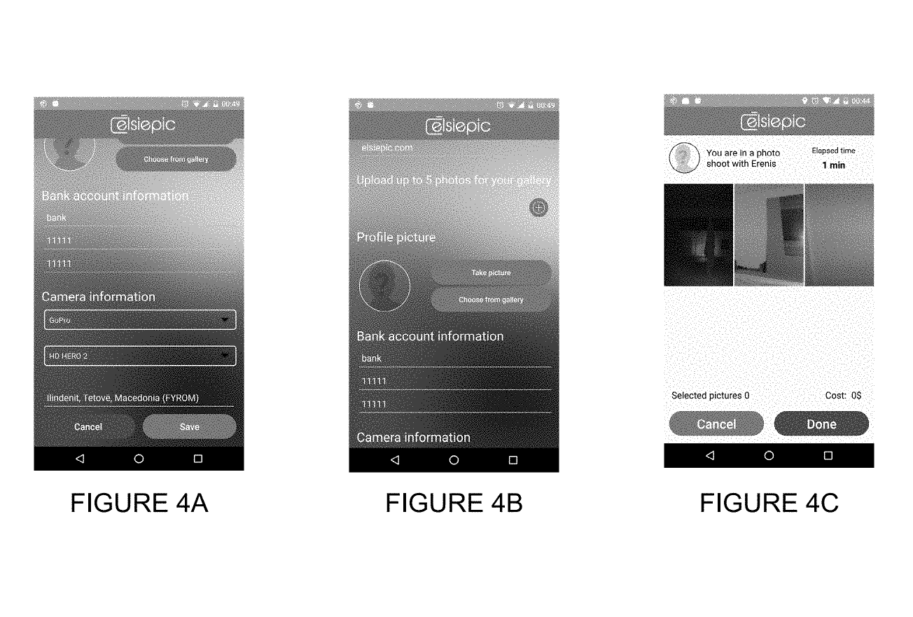

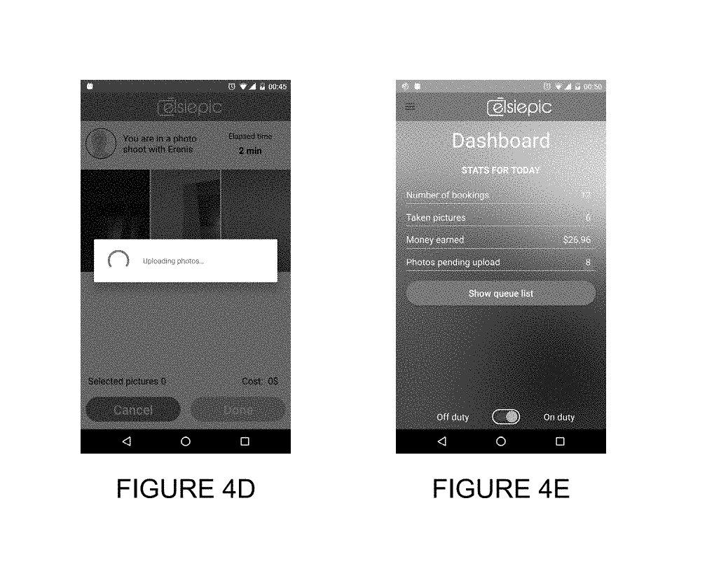

FIGS. 4A through 4E depict representative user interfaces for the app 128b on the photographer's smart phone 102. Again, those skilled in the art will recognize that all user interfaces are not depicted. Instead, for simplicity and clarity, only selected user interfaces significant to the ordered sequence of steps for the process described are shown. FIGS. 4A and 4B depict user interfaces by which a photographer may register to provide service, including identification of equipment owned or available and entry of account information for receiving payments. FIG. 4C illustrates captured images being shown for selection by the photographer for upload to the server. FIG. 4D illustrates an upload in progress. FIG. 4E illustrates a dashboard by which the photographer may indicate availability to provide service and review information from prior photoshoots.

While each process flow and/or event sequence depicted in the figures and described herein involves a sequence of steps and/or events, occurring either in series or in tandem, unless explicitly stated or otherwise self-evident, no inference should be drawn regarding specific order of performance of steps or occurrence of events, performance of steps or portions thereof or occurrence of events serially rather than concurrently or in an overlapping manner, or performance the steps or occurrence of the events depicted exclusively without the occurrence of intervening or intermediate steps or events. Moreover, those skilled in the art will recognize that complete processes and event sequences are not illustrated or described. Instead, for simplicity and clarity, only so much of the respective processes and event sequences as is unique to the present disclosure or necessary for an understanding of the present disclosure is depicted and described. Still further, the description of different embodiment is not meant to imply that features of the embodiments are necessarily mutually exclusive. Aspects of different embodiments may be readily combined.

While this disclosure has described certain embodiments and generally associated methods, alterations and permutations of these embodiments and methods will be apparent to those skilled in the art. Accordingly, the descriptions of example embodiments do not define or constrain this disclosure. Other changes, substitutions, and alterations are also possible without departing from the spirit and scope of this disclosure, as defined by the following claims.

What is claimed is:

1. A server, comprising:
a memory configured to store images organized by each of a customer identifier for a customer among a plurality of customers, a photographer identifier for a photographer among a plurality of photographers, and a transaction identifier, each of the plurality of customers having a unique customer identifier and each of the plurality of photographers having a unique photographer identifier;
a transceiver configured to communicate over a network with a first app executing on a first mobile device associated with the customer and having a first customer identifier for the customer, to communicate with a second app executing on a second mobile device associated with the photographer and having a first photographer identifier associated with the photographer, to send messages to and receive messages from the first app via the network, to send images to the first app via the network, to send messages to and receive messages from the second app via the network, and to receive images from the second app via the network; and
a processor configured to generate messages to be sent using the transceiver and to process messages received by the transceiver, the processor further configured to:
receive, from the first app, a first message requesting on-demand professional photography services,
in response to receiving the first message, assign a unique transaction identifier to the request for on-demand professional photography services from the first app and determine a location of the first mobile device,
based on the determined location of the first mobile device, identify a location of the second mobile device as matching a geographic area defined to encompass the location of the first mobile device,
in response to identifying the location of the second mobile device as matching the geographic area defined to encompass the location of the first mobile device, initiate transmission of a notification message to the second app of the request for on-demand professional photography services at the location of the first mobile device,
subsequent to initiating transmission of the notification message, receive, from the second app, a confirmation message for acceptance of the request for on-demand professional photography services at the location of the first mobile device,
subsequent to receipt of the confirmation message, receive a message from the second app associated with one or more images available for retrieval from a remote storage device, and
cause the one or more images to be stored in the memory for access by the first customer identifier, the first photographer identifier, and the transaction identifier for the request for on-demand professional photography services from the first app.

2. The server according to claim 1, wherein the processor is further configured to, subsequent to causing the one or more images to be stored in the memory, initiate a first payment transaction with the first app for purchase of one or both of
the requested on-demand professional photography services, or
at least one of the one or more images resulting from the requested on-demand professional photography services.

3. The server according to claim 2, wherein the processor is further configured to, prior to initiating the first payment transaction with the first app, provide a link to the first app for preview of the one or more images and receive an identification from the first app of each of the one or more images to be purchased via the payment transaction.

4. The server according to claim 3, wherein the link is configured to permit limit-duration access to preview images on a website.

5. The server according to claim 2, wherein the processor is further configured to, subsequent to completing the first payment transaction with the first app, initiate a second payment transaction with the second app for payment for the on-demand professional photography services resulting in the one or more images.

6. The server according to claim 1, wherein the second app is configured to wirelessly receive images from a camera employed by the photographer.

7. The server according to claim 1, wherein the first app and the second app are a single app operating in a customer mode to form the first app and in a photographer mode to form the second app.

8. A computer program product comprising machine executable instructions configured to execute on a mobile device having a memory, a processor, and a transceiver, wherein execution of the machine executable instructions causes the processor to:
transmit, to a server, a first message for a request for on-demand professional photography services and including information enabling determination of a location of the mobile device, wherein a unique transaction identifier is assigned to the request for on-demand professional photography services;
process a received indication of at least one photographer for providing the requested on-demand professional photography services that has been identified as having a location matching a geographic area defined to encompass the location of the mobile device;
transmit, to the server in response to the received indication, an acceptance of a photographer among the at least one photographer for the requested on-demand professional photography services; and
subsequent to occurrence of the requested on-demand professional photography services by the accepted photographer, process a message associated with a customer identifier for a customer using the mobile device, a photographer identifier associated with the accepted photographer, and the transaction identifier making one or more images stored remotely available for preview access by the customer identifier, the photographer identifier, and the transaction identifier.

9. The computer program product according to claim 8, wherein the machine executable instructions are configured to cause the processor to, in conjunction with processing the message, process a payment transaction for purchase of one or both of
the requested on-demand professional photography services, or
at least one of the one or more images resulting from the requested on-demand professional photography services.

10. The computer program product according to claim 9, wherein the message contains a link for preview of the one or more images and wherein the machine executable instructions are configured to cause the processor to, during processing of the payment transaction, initiate transmission of an identification of each of the one or more images to be purchased via the payment transaction.

11. The computer program product according to claim 8, wherein the message includes a link configured to permit limited-duration access to preview images on a website.

12. The computer program product according to claim 8, wherein the machine executable instructions are configured to cause the processor to, subsequent to completing the payment transaction, receive a link for access to full resolution versions of the one or more images purchased via the payment transaction.

13. The computer program product according to claim 8, wherein the machine executable instructions are configured to cause the processor to, subsequent to completing the payment transaction, receive a receipt for payment for at least the on-demand professional photography services resulting in the one or more images.

14. A computer program product comprising machine executable instructions configured to execute on a mobile device having a memory, a processor, and a transceiver, wherein execution of the machine executable instructions causes the processor to:
transmit, to a server, a first message indicating availability to provide on-demand professional photography services and including information enabling determination of a location of the mobile device;
process a received indication of a request for on-demand professional photography services by a customer identified as having a location matching a geographic area defined to encompass the location of the mobile device, wherein a unique transaction identifier is assigned to the request for on-demand professional photography services;
transmit, to the server in response to the received indication, an acceptance of the request for on-demand professional photography services and, subsequent to occurrence of the requested on-demand professional photography services, one or more images captured during the occurrence of the requested on-demand professional photography services,
wherein each of the one or more transmitted images has associated therewith a customer identifier for a customer that requested the on-demand professional photography services, a photographer identifier associated with the photographer, and the transaction identifier.

15. The computer program product according to claim 14, wherein the machine executable instructions are configured to cause the processor to, subsequent to transmission of the one or more images, process a payment transaction for payment to the photographer for one or both of
the requested on-demand professional photography services, or
at least one of the one or more images resulting from the requested on-demand professional photography services.

16. The computer program product according to claim 14, wherein the machine executable instructions are configured to cause the processor to wirelessly receive images from a camera employed by the photographer.

17. The computer program product according to claim 14, the machine executable instructions are configured to cause the processor to transmit an indication of availability of the photographer to provide on-demand professional photography services.

18. The computer program product according to claim 14, the machine executable instructions are configured to cause the processor to periodically transmit an updated indication of a location of the mobile device.
